(19) United States
(12) Patent Application Publication
(10) Pub. No.: US 2021/0350341 A1
(43) Pub. Date: Nov. 11, 2021

(54) METHOD FOR COLLECTING TRANSPORTATION FARE WITH LOCATION-BASED MOBILE ONETIME TICKETS

(71) Applicant: STraffic Co., Ltd., Seongnam-si Gyeonggi-do (KR)

(72) Inventors: Jong-Seop SONG, Seoul (KR); Chan-Mo YANG, Seoul (KR)

(73) Assignee: STraffic Co., Ltd., Seongnam-si Gyeonggi-do (KR)

(21) Appl. No.: 17/082,704

(22) Filed: Oct. 28, 2020

(30) Foreign Application Priority Data
May 8, 2020 (KR) 10-2020-0055396

(51) Int. Cl. G06Q 20/04; H04W 4/80; H04W 4/029; G07B 15/00; G06Q 50/30; G06Q 30/00; G06Q 30/02; G06Q 20/32; G01S 19/01

(52) U.S. Cl. CPC G06Q 20/0457; H04W 4/80; H04W 4/029; G07B 15/00; G06Q 50/30; G06K 7/1095; G06Q 30/0284; G06Q 20/3278; G06Q 20/3274; G01S 19/01; G06Q 2240/00; G06Q 30/0185

(57) ABSTRACT

Disclosed is a method for collecting a transportation fare using a mobile terminal. When the mobile terminal is adjacent to transportation means, a collection server issues a onetime boarding ticket which grants an authority to get on the transport means at a current location of the mobile terminal and transmits the onetime boarding ticket to the mobile terminal. A validator in the transportation means validates the onetime boarding ticket through short-range communication with the mobile terminal and transmits the validated result to the collection server. The collection server collects the transportation fare to the mobile terminal.

### CROSS-REFERENCE TO RELATED APPLICATION

This application is based on and claims priority under 35 U.S.C. § 119 to Korean Patent Application No. 10-2020-0055396, filed on May 8, 2020, the disclosure of which is herein incorporated by reference in its entirety.

### BACKGROUND

### 1. Field

The present disclosure relates to a method for collecting a public transportation fare, such as a subway, a bus, or a train, and more particularly, to a method for collecting a transportation fare capable of issuing a onetime boarding ticket to a mobile terminal to settle the transportation fare using the ticket.

### 2. Discussion of Related Art

Systems, which may collect for a public transportation fare, such as a subway, a bus, and a train, have been commercialized in various ways. A method for collecting a public transportation fare may be largely divided into a card-based system and an account-based system.

The card-based system is a system for paying a fee by charging cash directly into an IC card such as a smart card and uses it for payment. The card-based system is a system for charging cash to a card charger, inputting the charged amount to a card in advance, and deducting a transportation fare from a pre-paid amount every time the transportation fare is paid using the card. If the card approaches a validator installed at a gate of the bus or the subway, the transportation fare is deducted. The card-based system has the same effect as losing cash when a user loses a card. In addition, in order for the user to charge the card without inconvenience, a number of chargers need to be installed in a location such as a subway station or a bus stop, so the cost of manufacturing a separate charger is consumed and locations where the chargers are installed need to be secured.

The account-based system is a system in which a user deposits money in advance to an account connected to a smart card or connects a credit card to a smart card again and pays by credit card. The account-based system avoids the disadvantages of the card-based system as described above. However, when the card is recognized by the validator to get on transportation means, it is necessary to check the validity of the card or the like on the network, and as a result, the account-based system has the disadvantage in that the payment process is difficult to be smoothly performed when situations such as a network failure occur.

On the other hand, a method for paying a transportation fare by issuing a ticket for getting on a public transportation to a mobile terminal in a form of a QR code and approaching the mobile terminal to a validator when the user gets on the public transportation to recognize the QR code is also developed. The method has the advantage that there is no trouble or waste of issuing a separate paper-type ticket, and there is no inconvenience of carrying a separate smart card.

However, the QR code method only plays a role of changing the paper ticket to the QR code, and therefore may be used only when the transportation means which the user mainly gets on, a boarding section using the transportation means, and the like are determined in advance. Therefore, the method is mainly applied to booking a ticket, and is difficult to be applied, for example, to a case in which a subway fare increases with an increase in a boarding distance.

In addition, the currently commercialized methods as described above have the problems in which the entire collecting system needs to be changed a lot, for example, in the event of a situation such as a change in a fare system in the state that various types of transportation means exist and various types of fare systems are provided for each transportation means. For example, when a subway fare system for collecting using the smart card or the QR code is changed or a new type of collecting method is adopted, a subway operator needs to perform an operation of changing the validation system of the smart card or the mobile terminal according to the changed fare system or changing the fare system for all systems according to the boarding section.

### SUMMARY

The disclosure was devised to solve the problems of the existing traffic fare processing method as described above, and one or more embodiments of the disclosure is to provide a method for enabling a ticket held by a user to be usable in all transportation means by processing the ticket in a consistent manner regardless of characteristics (fare policy, reservation status, authentication method, and the like) of the transportation means at the time of using the ticket so that the ticket may be used in various types of transportation means.

One or more embodiments of the disclosure is to provide a transportation ticketing system for mobility as a service (MaaS) that issues a digitized mobile ticket to enable all users carrying a mobile to use various types of transportation services in a familiar and batch manner by using the mobile without carrying a physical ticket, and reduces an operation cost of a transportation operator by allowing the system to perform issuance/management/authentication and fare settlement of a card that the transportation operator has previously performed.

According to an aspect of an embodiment, provided is a method for collecting a transportation fare performed by a collection server that communicates with a user mobile terminal and a validator provided for transportation means used by a user. The method for collecting a transportation fare includes: a) checking, by the collection server, whether the mobile terminal is located adjacent to the transportation means within a predetermined distance; b) issuing, by the collection server, a onetime boarding ticket, which grants an authority to get on the transportation means at a current location of the mobile terminal, to the mobile terminal by checking that the mobile terminal is located adjacent to the transportation means in step a); and c) transmitting a result of validating, by the validator, the onetime boarding ticket through short-range communication with the mobile terminal to the collection server and receiving, by the collection server, the validated result.

According to a preferred embodiment of the disclosure, the step a) may include: a-1) receiving, by the mobile terminal, a signal from a signal generator fixed at a location adjacent to the transportation means; and a-2) transmitting, by the mobile terminal, a signal generator ID, which is identification information of the signal generator received from the signal generator, to the collection server.

In the step a-2), the mobile terminal may transmit location information of the transportation means to the collection server.

The location information may be the signal generator ID.

The method for collecting a transportation fare may further include: after the step c), d) checking, by the collection server, the location of the transportation means during movement of the transportation means; e) issuing, by the collection server, a onetime get-off ticket, which grants an authority to get off the transportation means at the current location of the transportation means, to the mobile terminal; and f) transmitting a result of validating, by the validator, the onetime get-off ticket through the short-range communication with the mobile terminal to the collection server and receiving, by the collection server, the validated result.

The onetime get-off ticket may be issued corresponding to the onetime boarding ticket. As an example, a unique number assigned to the onetime boarding ticket may be added to the onetime get-off ticket.

The step d) may include: d-1) receiving, by the mobile terminal, a signal from another signal generator fixed at a location adjacent to the transportation means during the movement of the transportation means; and d-2) transmitting, by the mobile terminal, another signal generator ID, which is identification information of the another signal generator received from the another signal generator, to the collection server.

In the step d-2), the mobile terminal may transmit the location information of the transportation means to the collection server. At this time, the location information may be the another signal generator ID.

The collection server may settle a transportation fare for the mobile terminal according to the validated result in the step c) or the step f).

According to a preferred embodiment of the disclosure, the step a) may include: a-1) receiving, by the mobile terminal, a signal from a signal generator provided in the transportation means; and a-2) transmitting, by the mobile terminal, a signal generator ID, which is identification information of the signal generator received from the signal generator, to the collection server together with the location information of the transportation means.

The location information may include at least one of a stop ID adjacent to the transportation means, a location of the mobile terminal, and a location calculated by a GPS device of the transportation means.

The method for collecting a transportation fare may further include: after the step c), d) checking, by the collection server, the location of the transportation means during movement of the transportation means; e) issuing, by the collection server, a onetime get-off ticket, which grants an authority to get off the transportation means at the current location of the transportation means, to the mobile terminal; and f) transmitting a result of validating, by the validator, the onetime get-off ticket through the short-range communication with the mobile terminal to the collection server and receiving, by the collection server, the validated result.

The onetime get-off ticket may be issued corresponding to the onetime boarding ticket. As an example, a unique number assigned to the onetime boarding ticket may be added to the onetime get-off ticket.

The step d) may include: d-1) receiving, by the mobile terminal, a signal from the signal generator provided in the transportation means during the movement of the transportation means; and d-2) transmitting, by the mobile terminal, the signal generator ID received from the signal generator, to the collection server together with the location information of the transportation means.

The location information of the transportation means may include the location of the mobile terminal calculated by a GPS device of the mobile terminal.

The signal from the signal generator may include the location information of the transportation means.

The location information of the transportation means may include at least one of a stop ID adjacent to the transportation means and a location calculated by the GPS device of the transportation means.

Meanwhile, in the step c), the validator may transmit the validated result to the collection server when it is checked whether the onetime boarding ticket is a ticket granting an authority to get on the transportation means at the current location.

The onetime boarding ticket may be limited in use time.

The onetime boarding ticket may be composed of any one of a QR code ticket, an NFC ticket, and a Bluetooth ticket.

The onetime boarding ticket may be issued by reflecting a past boarding history of the user of the mobile terminal.

According to the disclosure, it is possible for the user to pay only with a mobile terminal without carrying a separate transportation fare payment means such as a smart card. At this time, the onetime tickets according to the disclosure are not approved when the onetime tickets are used outside the issued location or after the validity period has passed, so the onetime tickets cannot be used even if the onetime tickets are illegally duplicated by others. In addition, since the onetime tickets do not include sensitive personal information to be protected, for example, a separate IC chip for safely storing the tickets is unnecessary.

In addition, according to the disclosure, even when the situations such as the change in the fare system of the transportation means occur, the operator of the public transportation may collect without having to change his/her system.

Further, according to the disclosure, the global fare payment as a service (global FPaaS) is possible. The FPaaS is a method in which transportation operators process a transportation fare through an external fare processing agency without directly operating the automatic fare collection (AFC) system, and the FPaaS using the existing smart card has a technical problem in scalability. However, according to the disclosure, the offline authentication system performs the collection processing, but there is no burden of updating the card list and the fare processing logic in the card reader, which is a disadvantage of the existing offline system.

Furthermore, according to the disclosure, the global FPaaS is possible. That is, according to the disclosure, the transportation operator may sell the fare product online regardless of where the transportation operator operates the system, and the user may always receive the ticket by the user mobile regardless of where the user uses the transportation service. In addition, even if the number of transportation operators or users subscribed to the service increases, there is no problem in the system operation performance.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is a schematic diagram of a transportation fare collection system according to the disclosure.

FIG. 2 is a diagram schematically illustrating a transportation fare collection process performed by the system of FIG. 1.

FIG. 3 is a diagram for describing an embodiment in which the disclosure is applied for subway boarding.

FIG. 4 is a diagram for describing an embodiment in which the disclosure is applied for bus boarding.

FIG. 5 is a diagram illustrating a structure of data in which a beacon in a bus of FIG. 4 is transmitted to a mobile terminal.

FIG. 6 is a diagram for describing another embodiment of FIG. 4.

### DETAILED DESCRIPTION

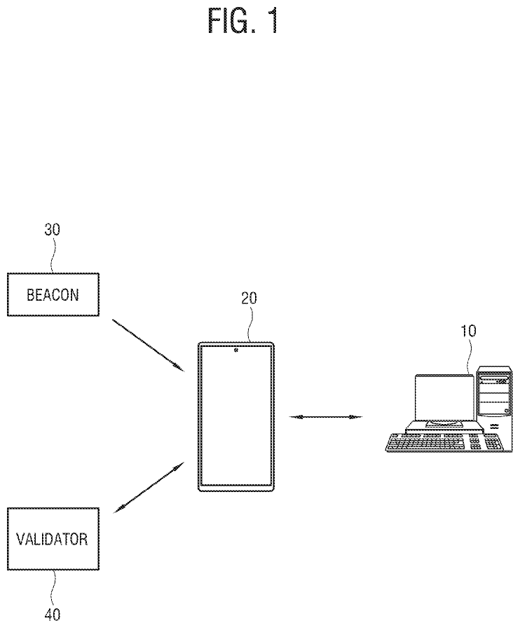

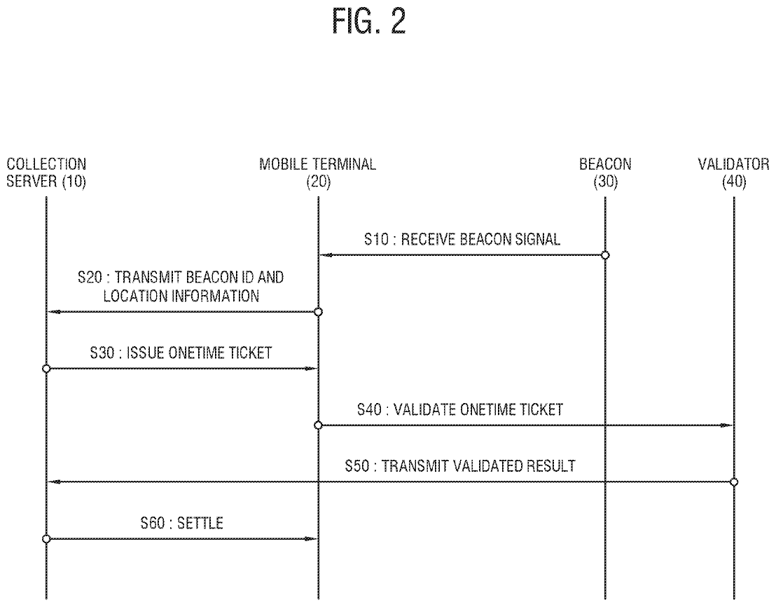

Hereinafter, the disclosure will be described in more detail with reference to the accompanying drawings. First, a basic concept of the disclosure will be described with reference to FIGS. 1 and 2, and then, specific embodiments for each transportation means will be described.

FIG. 1 is a schematic diagram of a transportation fare collection system according to the disclosure.

The collection system according to the disclosure is configured to include a collection server 10, a mobile terminal 20, a beacon 30, and a validator 40.

The collection server 10 is a server that performs a main process of the disclosure, and performs processes of receiving a beacon ID and location information from the mobile terminal 20, issuing onetime tickets to the mobile terminal 20, receiving results of validating the onetime tickets by the validator 40, settling a transportation fare for the mobile terminal 20, and the like.

The mobile terminal 20 is a terminal carried by a user who wants to use transportation means. The mobile terminal 20 has a function of communicating with the collection server 10, a function of receiving a signal from the beacon 30, a function of communicating with the validator 40 by near field communication (NFC), Bluetooth, QR code scanning, and the like. The function of the mobile terminal 20 may be implemented by applications that drive various hardware installed in the mobile terminal 20.

The beacon 30 functions as a signal generator that broadcasts a signal to the mobile terminal 20. All the beacons 30 have their own unique beacon IDs, and the beacon ID corresponds to a signal generator ID according to the disclosure. The signal broadcast by the beacon 30 may include only the beacon ID or may include both the beacon ID and the location information. The beacon 30 is installed in the transportation means or fixedly installed in a location adjacent to the transportation means. It is preferable that when the transportation means is, for example, a bus, the beacon 30 is installed in the transportation means, and when the transportation means is, for example, a subway, the beacon 30 is installed in a subway station or at a specific location adjacent to the subway station. According to the disclosure, the beacon 30 is an example of a signal generator, and various devices in addition to the beacon 30 may be applied to the disclosure as long as they may transmit their own identification information or transmit identification information and location information.

The validator 40 has a function of performing short-range communication with the mobile terminal 20, and uses the function to recognize and validate onetime tickets issued from the collection server 10 for the mobile terminal 20. The validator 40 may also communicate with the collection server 10 by means communicating with a separate external network therein, and uses the communication to perform the function of transmitting the validated results of the onetime tickets to the collection server 10.

The validator 40 is installed at a location where a user enters to get on or off the transportation means. For example, when the transportation means is a bus, the validator 40 is installed near an entrance door in the transportation means, and when the transportation is a subway, the validator 40 is installed near an entry/exit gate through which passengers enter a subway platform from the outside or exit from the platform to the outside. In addition, the validator 40 has a function of communicating with the beacon 30 when the beacon 30 is installed in the transportation means, and uses the function to transmit the location information to the beacon 30.

FIG. 2 is a diagram schematically illustrating a transportation fare collection process performed by the system of FIG. 1. Hereinafter, each step of FIG. 2 will be described.

### Step S10

As a user moves while carrying the mobile terminal 20, the mobile terminal 20 may receive a broadcasting signal from the beacon 30 in the vicinity thereof The beacon 30 has a broadcasting area of approximately several meters to several tens of meters. The mobile terminal 20 may not receive a signal from the beacon 30 in a state in which the mobile terminal 20 is located outside the broadcasting area of the beacon 30, but when the mobile terminal 20 approaches a certain beacon 30 as the user moves or the mobile terminal 20 approaches the beacon 30 while the user is waiting at a bus stop, the mobile terminal 20 receives the signal from the beacon 30.

The signal broadcast by the beacon 30 includes a beacon ID, and optionally and preferably includes location information of the beacon 30. The location information means information on a point where a use of onetime tickets is permitted when the onetime tickets are issued, which may be the location of the beacon 30, the location of the transportation means, or the location of the mobile terminal 20. According to the disclosure, any one of these three locations may be used as the location information, so these three locations are used as terms having the same value.

The location information of the beacon 30 may be the beacon ID itself if the beacon 30 is installed at a fixed location. The collection server 40 has data matching information on the installation location for each beacon ID, and accordingly, it is possible to know the location of the beacon 30 by querying the matched data when the beacon ID is received.

When the beacon 30 is not installed at a fixed location, but is installed in transportation means such as a bus, the location of the beacon 30 changes as the transportation means moves. In this case, the beacon 30 receives its own location information through a separate location recognition means installed in the transportation means. As an example, the validator 40 installed in the bus receives a stop ID, which is the identification information of the bus stop, from a short-range communication device installed in each bus stop, and the validator 40 provides the stop ID to the beacon 30 in the bus. Accordingly, the beacon 30 in the bus may broadcast the stop ID to the mobile terminal 20. The collection server 40 has data matching information on the locations for each stop ID, and accordingly, it is possible to know the location of the beacon 30 based on the location of the corresponding stop ID by querying the matched data when the stop ID is received. As another example, a GPS device is installed in the bus, and the GPS device detects the location of the bus itself and transmits the detected location information to the beacon 30. The beacon 30 may broadcast the location information of the bus received from the GPS device together with its own beacon ID to the mobile terminal 20.

### Step S20

The mobile terminal 20 receiving the signal from the beacon 30 transmits the beacon ID and the location information of the beacon 30 to the collection server 10. Accordingly, the collection server 10 may know that the mobile terminal 20 is at a location where the mobile terminal 20 uses a specific transportation means.

If the beacon 30 does not provide the location information to the mobile terminal 20, the mobile terminal 20 may transmit the location information that the mobile terminal 20 detects of one's own accord as the location information to be transmitted to the collection server 10. The location information of the mobile terminal 20 itself may be calculated by the GPS device provided in the mobile terminal 20, or may be obtained by allowing the mobile terminal 20 to detect identification information of another communication access point (AP) that exists at a location adjacent to the mobile terminal 20 and communicates with the mobile terminal 20.

### Step S30

The collection server 10 issues onetime tickets, which grant an authority to get on transportation means at the current location, to the mobile terminal 20. The issuance of the onetime tickets is performed by transmitting the information to be included in the onetime tickets, and an eventual type of onetime tickets generated by the mobile terminal 20 may be various types recognized by the validator 40. For example, the onetime tickets may be composed of a QR code ticket, a NFC ticket, a Bluetooth ticket, and the like.

The onetime tickets include the beacon ID and the location information of the beacon 30 that the mobile terminal 20 transmits. In addition, the onetime tickets include information on a time limit on which these tickets are available. For example, the use time of the onetime tickets may be set to be 5 minutes from an issuance time.

On the other hand, in issuing the onetime tickets, the collection server 10 may issue onetime tickets by reflecting a past boarding history of the mobile terminal 20, for example, a history of transportation products purchased by the user and a boarding history performed under the details. As an example, the onetime tickets may be issued as tickets in which a user's boarding section is preset. That is, the collection server 10 stores the information on the onetime tickets that have been issued and used in the past for the mobile terminal 20, and if all records that a user has used in the past is from the current location of the mobile terminal 20 to stop A, the collection server 10 may issue onetime tickets that can get on from the current location to the stop A.

Meanwhile, as described above, the onetime tickets may be issued in the form of the QR code ticket, the NFC ticket, the Bluetooth ticket, and the like. The NFC ticket is a ticket configured to be recognized by the validator 40 through short-range communication when the mobile terminal 20 approaches the validator 40 in a certain distance, and therefore, has the advantage of being able to recognize the onetime tickets in a contactless manner. The Bluetooth ticket is a ticket in a data format that may be recognized through the Bluetooth communication among the short-range communication methods, which may have some limitations because the Bluetooth communication function of the mobile terminal 20 needs to be activated and the mobile terminal 20 and the validator 40 need to be paired. The QR code ticket is based on a method in which the validator 40 checks the information on the onetime tickets by scanning, by the validator 40, the QR code displayed on the screen of the mobile terminal 20, and therefore, has the advantage of being very fast and convenient to use. As a result, the QR code ticket is best suited to be adopted as the onetime tickets according to the disclosure.

When the onetime tickets are issued in the form of the QR code, it may be possible for the collection server 10 to directly generate the QR code, but in reality, the QR code is preferably generated by the mobile terminal 20. That is, the collection server 10 transmits only the data to be included in the onetime tickets to the mobile terminal 20 in step S30, and the mobile terminal 20 converts the received data into the QR code to generate the onetime tickets in the form of the QR code. To this end, an application (App) for generating the data of the received onetime tickets with the QR code needs to be installed in the mobile terminal 20 in advance. To implement the disclosure, the application is prepared to be included in an app for transportation fare payment according to the disclosure that performs the process according to the disclosure for the collection server 10.

Meanwhile, when there are a plurality of beacons 30 approaching the mobile terminal 20, the mobile terminal 20 may perform steps S10 and S20 on the plurality of beacons 30. For example, after any one of the beacons 30 is adjacent to the mobile terminal 20, other beacons 30 may be adjacent to the mobile terminal 20. In this case, the collection server 10 performs the operation of issuing the onetime tickets to the mobile terminal 20 through step S30 on each beacon 30.

### Step S40

The user of the mobile terminal 20 receiving the onetime tickets gets on the corresponding transportation means, and the mobile terminal 20 approaches the validator 40 provided in the corresponding transportation means. Accordingly, the validator 40 recognizes the onetime tickets issued to the mobile terminal 20 through the short-range communication. Accordingly, the onetime tickets are executed for the boarding of the transportation means. At this time, the validator 40 checks whether the onetime tickets are tickets recorded with the information on the beacon 30 of the transportation means in which the validator 40 is installed, and whether the location information matches the current location of the transportation means, and recognizes the onetime tickets as boarding permission tickets when it is checked that the location information matches the current location of the transportation means. In addition, when a validity time is set for the onetime tickets, the validator 40 checks whether the time when the onetime tickets are executed is within the range of the validity time. When it is checked that information on other beacons is recorded, the location information is mismatched, or the onetime tickets are onetime tickets that have expired, the validator 40 does not approve the onetime tickets and displays a boarding refusal message. The validator 40 may be configured to further detect whether the onetime tickets are duplicated or ticket information is counterfeited.

Meanwhile, as described above, when the mobile terminal 20 recognizes the plurality of beacons 30 in step S10, the plurality of onetime tickets are issued in step S30. In this way, when the mobile terminal 20 receives the plurality of onetime tickets, for example, in the case of the QR code ticket, the mobile terminal 20 generates a plurality of QR codes, so when the user of the mobile terminal 20 gets on transportation means, an error may occur in which QR codes other than the QR code issued corresponding to the corresponding transportation means is used. Various methods can be considered as a method for preventing the error. For example, when another QR code is generated after one QR code is generated, the previously generated QR code may be deleted by the mobile terminal 20, or only the QR code for the transportation means having the strongest signal strength of the beacon is left and the remaining QR codes may be deleted by the mobile terminal 20.

As another method, when the mobile terminal 20 receives one onetime ticket and generates a QR code for the onetime ticket, and then receives additional onetime tickets from the collection server 10, a method for creating a QR code to include information on all previously received onetime tickets when the mobile terminal 20 generates the additional QR codes can be employed. That is, the information on all onetime tickets is included in one QR code. In this case, the mobile terminal 20 displays only the finally generated QR code among all the previously generated QR codes. When the final QR code is recognized by the validator 40, the validator 40 reads information on all the onetime tickets, and the validator 40 approves the information of the onetime ticket corresponding only to the validator 40 itself among the read onetime tickets.

### Step S50

The validator 40 transmits the validated results to the collection server 10 when the onetime tickets are approved. Accordingly, the collection server 10 uses the onetime tickets issued by the collection server 10 to know that the user of the mobile terminal 20 gets on the corresponding transportation means.

### Step S60

The collection server 10 settles the boarding fare for the mobile terminal 20. The settlement of the boarding fare may be performed by, for example, a method for subtracting a boarding fare from an amount that is charged on the mobile terminal 20 in advance, performing a payment process for a credit card linked to the mobile terminal 20, or the like.

In accordance with the above configuration of the disclosure, the collection server 10 automatically issues onetime tickets when the mobile terminal 20 is adjacent to the beacon 30 installed for the transportation means. When a validity time of onetime tickets has elapsed without the mobile terminal 20 getting on the transportation means, the onetime tickets automatically disappears. In addition, if the mobile terminal 20 approaches the beacons 30 other than the beacon 30 to which the ticket is issued after the onetime tickets are issued, the above-described process is performed again to newly issue onetime tickets to the newly approached beacon 30. At this time, the previously issued onetime tickets will be included to the composite onetime ticket or will be canceled as a predetermined time has lapsed.

According to this method, the user of the mobile terminal 20 may be automatically issued onetime tickets simply by carrying the mobile terminal 20 and approaching the transportation means. In addition, from the viewpoint of the operator of the transportation means, a process for the payment of the transportation fare is terminated by validating, by the validator 40, the onetime tickets issued to the mobile terminal 20 and notifying the collection server 10 of the validated onetime tickets, and the transportation fare is settled for the collection server 10 afterwards. In addition, even if a situation such as a change in the fare system of the transportation means occurs, the operator of the transportation means need not to perform a modification operation to change software for the validator 40 to change the amount to be collected to the smart card in the existing card-based system, for example, and may immediately reflect the changed fare system only by notifying the collection server 10 of the changed fare system. That is, the application of the changed fare system can be easily made only by changing the amount to be charged to the user of the mobile terminal 20 for the onetime tickets issued by the collection server 10.

Furthermore, the onetime tickets according to the disclosure have the limited validity time and also include the location information detected through beacons 30 and the like. The validator 40 in the transportation means may read the validity time of the onetime tickets to check whether the onetime tickets have been used within the available time, and may read the location information and/or beacon ID of the onetime tickets to check whether the onetime tickets are issued to grant a boarding authority to the transportation means itself. Therefore, the counterfeit use, misuse, or the like of the onetime tickets issued to another person's mobile terminal 20 is prevented.

Hereinafter, a specific embodiment of the disclosure applied to specific transportation means such as a subway or a bus will be described.

### First Embodiment

A first embodiment illustrates a case where the disclosure is applied to a subway. As described above, when a beacon 30 is stationary, a location of the beacon 30 may be detected only by information on a beacon ID, but when the beacon 30 is mobile, a separate location detection means needs to be provided to detect the location of the beacon 30. In the case of the subway, the beacon 30 may be mounted on a subway vehicle to be configured to be mobile. However, when considering that a passenger needs to pass through an entrance gate to go to the platform in the case of using the subway, in the case of the subway, the beacon 30 is preferably fixedly installed at a specific point around a subway station. For example, the beacon 30 may be installed near the entrance gate toward the platform, or may be installed in the middle of a stair to enter the subway station.

On the other hand, a subway usually have a fare system that is configured to increase a fare as a boarding distance increases. Therefore, it is necessary for a user to detect a section using the subway in order to make the collection in accordance with the distance using the subway. To this end, the present embodiment proposes a method for issuing onetime tickets by separating the onetime tickets into a onetime boarding ticket and a onetime get-off ticket.

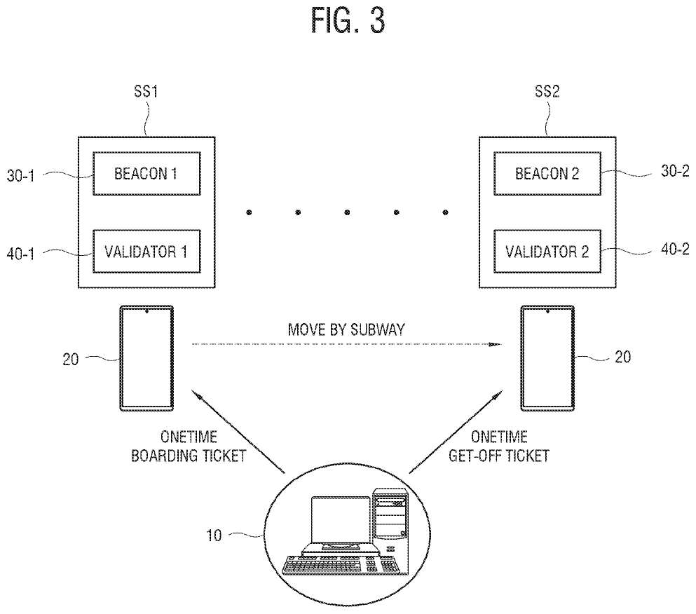

FIG. 3 is a diagram for describing an embodiment in which the disclosure is applied for subway boarding.

A beacon 1 30-1 and a validator 1 40-1 are installed at subway station 1 SS1, which is a subway station that a user wants to get on the subway. The beacon 1 30-1 is installed at a location next to the subway station 1 SS1 or near an entrance gate, and the validator 1 40-1 is installed at the entrance gate to check whether the user mobile terminal 20 gets on the subway, that is, the user mobile terminal 20 has passed through the entrance gate. Similarly, a beacon 2 30-2 and a validator 2 40-2 are installed at subway station 2 SS2 which is a subway station that the user wants to get off after moving using the subway. The beacon 2 30-2 is also installed at a location immediately next to the subway station 2 SS1 or near an exit gate, and the validator 2 40-2 is installed at the exit gate to check whether the user mobile terminal 20 gets off the subway, that is, the user mobile terminal 20 has passed through the exit gate.

When the user approaches the subway station 1 SS1 while carrying the mobile terminal 20, the process of steps S10 to S30 of FIG. 2 described above between the beacon 1 30-1 and the mobile terminal 20 and the collection server 10 is performed before the user reaches the entrance gate to issue onetime tickets. At this time, the issued ticket is a onetime boarding ticket that permits only boarding. When the mobile terminal 20 passes through the entrance gate of the subway station 1 SS1, the mobile terminal 20 is validated by the validator 1 40-1 to perform the process of steps S40 and S50 of FIG. 2. Accordingly, the collection server 10 realizes that the onetime boarding ticket that the collection server 10 has issued to the mobile terminal 20 is actually used so that the user of the mobile terminal 20 gets on the subway at the subway station 1 SS1.

The process of steps S10 to S30 of FIG. 2 described above between the beacon 2 30-2 and the mobile terminal 20 and the collection server 10 is performed when the user moves by the subway to reach the subway station 2 SS2 which is his/her desired destination, and thus the onetime tickets are reissued. At this time, the issued ticket is a onetime get-off ticket that grants an authority to get off the subway at the current location.

In the process of performing these steps S10 to S30, when the conditions for issuing the onetime tickets are met, that is, when the collection server 10 is notified from the mobile terminal 20 that the mobile terminal 20 receives the signal from the beacon 2 30-2, first, the collection server 10 checks whether the previously executed onetime boarding ticket exists for the mobile terminal 20. When the previously executed onetime boarding ticket exists, the collection server 10 issues the onetime get-off ticket, and when the previously executed onetime boarding ticket does not exist, the collection server 10 issues the onetime boarding ticket. When the collection server 10 receives the communication with the beacon 2 30-2 from the mobile terminal 20, it may not be unknown whether the user wants to get on or off. However, when the previously issued and executed onetime boarding ticket exists, the collection server 10 determines that the user wants to get off the transportation means that the user is currently getting on, and when the previously issued and executed onetime boarding ticket does not exist, the collection server 10 may determine that the user wants to get on the transportation means at the current location of the mobile terminal 20.

The onetime get-off ticket is issued corresponding to the onetime boarding ticket. As an example, the collection server 10 may establish a correspondence relationship by adding a unique number, which is assigned to the onetime boarding ticket, to the onetime get-off ticket. By establishing the corresponding relationship as described above, the collection server 10 may check the boarding section without error by detecting a user's boarding point and a getting off point corresponding to the boarding point.

When the mobile terminal 20 to which the onetime get-off ticket is issued passes through the exit gate of the subway station 2 SS2, the mobile terminal 20 is validated by the validator 2 40-2 and the process of steps S40 and S50 of FIG. 2 is performed. Accordingly, the collection server 10 realizes that the onetime get-off ticket that the collection server 10 has issued to the mobile terminal 20 is actually used so that the user of the mobile terminal 20 gets off at the subway station 2 SS2.

Accordingly, the collection server 10 checks that the section in which the user uses the subway is from the subway station 1 SS1 to the subway station 2 SS2, and performs the process of step S60 of FIG. 2 to settle the fare for the corresponding section for the mobile terminal 20.

According to the first embodiment as described above, in the case where the fare increases according to the boarding section like the subway, it is possible to accurately detect the boarding section and collect the corresponding fare.

As described above in the description of FIG. 2, since the location of the beacon installed in the subway station is fixed, it is possible to detect the location information only by detecting the beacon ID. At this time, the location information is not necessarily information on a geographic location, but may be identification information on a subway station. That is, the collection server 10 has data about the beacon ID and the subway station where the beacon is installed. Therefore, the collection server 10 may detect at which station the user gets on and at which station the user gets off only by detecting the beacon ID. The collection server 10 may collect an accurate transportation fare by querying a fare table for the corresponding section.

Meanwhile, while the subway moves from the subway station 1 SS1 toward the subway station 2 SS2, the subway passes through other subway stations between the subway station 1 SS1 and the subway station 2 SS2. At this time, the mobile terminal 20 may receive a broadcasting signal from a beacon of an intermediate subway station, and accordingly, the process of steps S10 to S30 of FIG. 2 may be performed to issue an unintended onetime get-off ticket. However, even if the unintended onetime get-off ticket is issued, when the onetime get-off ticket does not pass through the validator installed at the exit gate of the corresponding intermediate subway station, the onetime get-off ticket is not executed, so there is no problem of error settlement due to the issuance of the unintended onetime get-off ticket. Then, when the subway moves further and reaches another subway station, another onetime get-off ticket is issued by communication with the beacon of the subway station, and at the same time, the previously issued onetime get-off ticket disappears or invalidated.

If the user finally reaches the subway station 2 SS2 while the above process is repeated, the onetime get-off ticket issued for the subway station 2 SS2 is executed by the validator 2 40-2, and thus, the process of steps S40 to S60 is performed.

### Second Embodiment

A second embodiment illustrates a case where the disclosure is applied to a bus.

In the case of a bus, there may be a flat rate system in which the same amount is collected regardless of a boarding distance, and there may be a distance rate system in which a fare varies depending on the distance or sections of movement. In the case of the flat rate system, it is unnecessary to detect the boarding section, so the process illustrated in FIG. 2 may be applied only once before a user gets on a vehicle to collect the accurate fare. However, in the case of the section rate system or a distance rate system, it is necessary to accurately detect the boarding sections. Therefore, in the case of the section fare system, the method for issuing a onetime boarding ticket and issuing a onetime get-off ticket above described in the first embodiment of FIG. 3 is similarly applied.

However, in the case of the bus, the beacon is mounted in the vehicle, and therefore moves with the vehicle. Therefore, the accurate collection is possible only when the location information of the point where the user gets off the bus needs to be accurately detected by a separate means.

In addition, the mobile terminal 20 may unintentionally approach beacons other than the beacon in the vehicle while the user moves by the vehicle, and as a result, it is difficult to apply the method for issuing a onetime get-off ticket according to the first embodiment as it is. Therefore, in the present embodiment, it is necessary to apply another modified method for the method for issuing a onetime get-off ticket.

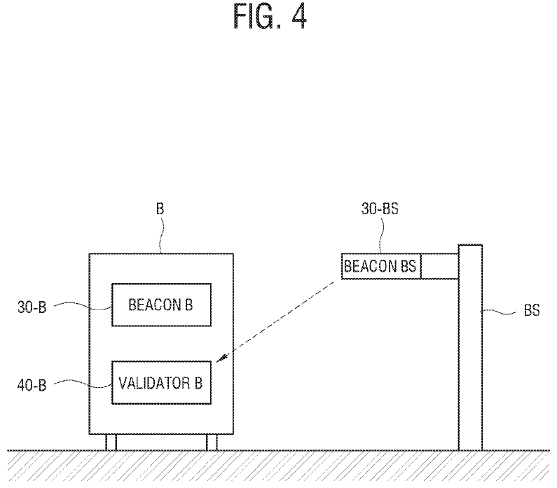

FIG. 4 is a diagram for describing an embodiment in which the disclosure is applied for bus boarding, and specifically, is a diagram for describing a method for a mobile terminal 20 to acquire location information of a beacon in a bus.

A beacon B 30-B and a validator B 40-B are provided in a bus B. The beacon B 30-B and the validator B 40-B move with the bus B in the bus B. A beacon BS 30-BS which is another beacon is installed at a bus stop BS. The beacon BS 30-BS broadcasts a stop ID which is identification information of the bus stop, and the validator B 40-B in the bus B receives a signal broadcast by the beacon BS 30-BS. To this end, the validator B 40-B is separately provided with a receiving device for receiving the signal from the beacon of the bus stop.

As the bus B approaches the bus stop BS, the validator B 40-B in the bus B receives the signal of the beacon BS 30-BS to acquire the stop ID. The validator B 40-B delivers the stop ID to the beacon B 30-B, and thus, the beacon B 30-B receives the information of the stop ID.

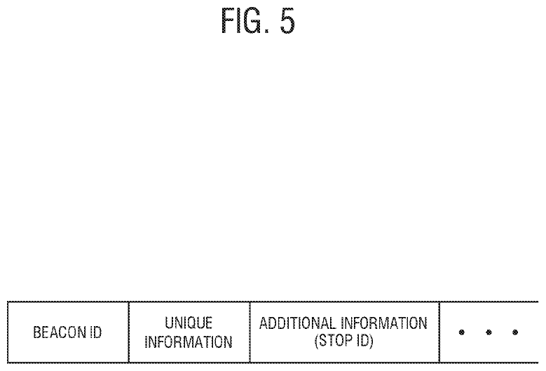

FIG. 5 is a diagram illustrating a structure of data in which a beacon in a bus of FIG. 4 is transmitted to a mobile terminal. The data broadcast by the beacon is configured to include a beacon ID, unique information, additional information, and the like as illustrated in FIG. 5. The stop ID is recorded in a space including additional information among each of the fields. Accordingly, the beacon B 30-B broadcasts the stop ID together with its own beacon ID.

The collecting process by this configuration is as follows.

While the user is standing at the bus stop BS to get on the bus, the mobile terminal 20 receives the signal broadcast by the beacon B 30-B as the bus B approaches the bus stop BS. Accordingly, step S10 of FIG. 2 is performed. At this time, the validator B 40-B of the bus B receives the stop ID from the beacon BS 30-BS of the bus stop and delivers the received stop ID to the beacon B 30-B, so the beacon B 30-B transmits the signal including the stop ID to the mobile terminal 20. Accordingly, the mobile terminal 20 receives its own beacon ID from the beacon B 30-B and receives the stop ID as the location information.

The mobile terminal 20 performs step S20 of FIG. 2 by transmitting the beacon ID and the stop ID to the collection server 10. The collection server 10 issues a onetime boarding ticket to the mobile terminal 20, the onetime boarding ticket issued to the mobile terminal 20 is approved by the validator B 40-B in the bus (B) as the user gets on, and the validator B 40-B transmits the validated result to the collection server 10, so the steps S30 to S50 of FIG. 2 are performed.

Meanwhile, the process in which the onetime get-off ticket is issued while the bus B is moving is similar to the first embodiment described above.

However, in the case of the bus B, the beacon in which the mobile terminal 20 receives the signal does not change during the movement of the bus B, but is continuously maintained as the beacon B 30-B during the boarding. Therefore, when the content of the signal received from the beacon B 30-B changes, specifically, when the stop ID information recorded in the additional information field of FIG. 5 changes, the mobile terminal 20 performs the process of transmitting the beacon ID and the location information to the collection server 10 as in the step S20 of FIG. 2. Accordingly, the process of issuing the onetime get-off ticket, the process of canceling the previously issued onetime get-off ticket as the stop ID transmitted from the beacon B 30-B changes again while the issued onetime get-off ticket is not executed and issuing a new onetime get-off ticket, and the like are the same as the first embodiment described above.

In this way, even when the beacon in which the mobile terminal 20 receives the signal like the bus B is continuously maintained while boarding, the issuance and execution of the onetime boarding ticket and the onetime get-off ticket and the calculation and collection of the boarding distance accordingly are performed.

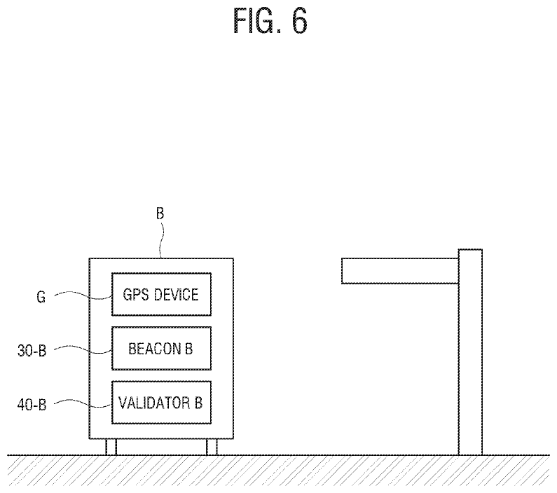

FIG. 6 is a diagram for describing another embodiment of FIG. 4, and specifically, is a view for describing another method for a mobile terminal 20 to acquire location information of a beacon in a bus.

In addition to a beacon B 30-B and a validator B 40-B, a separate GPS device G is provided in a bus B. The GPS device G receives a GPS signal transmitted from the outside, calculates its own location, and transmits the calculated location to the beacon B 30-B. Accordingly, the beacon B (30-B) receives the location information of the bus (B), and the received location information is recorded in an additional information field of the beacon data in the manner as illustrated in FIG. 5. The location information calculated by the GPS device G may be first transmitted to the validator B 40-B and then transmitted to beacon B 30-B by the validator B 40-B.

As described above, according to the configuration of FIG. 4 or 6, the beacon B 30-B acquires its own location information and transmits the acquired location information to the mobile terminal 20 together with the beacon ID.

Meanwhile, as another example of gathering the location information, the mobile terminal 20 may be configured to calculate its own location information. For example, when the mobile terminal 20 is equipped with the GPS device, the mobile terminal 20 calculates its own location using the GPS device. In this case, the beacon B 30-B does not need to transmit the location information to the mobile terminal 20, and the mobile terminal 20 receives only the beacon ID from the beacon B 30-B and transmits the beacon ID to the collection server 10 together with the location information calculated by the mobile terminal 20. The location of the mobile terminal 20 may be detected in various manners such as a manner in which a location is calculated based on identification information of a nearest access point (AP) to a WiFi communication network in addition to the GPS device.

On the other hand, the location of the bus B continuously changes in a manner in which the location information is obtained by the GPS device G in the bus B or the mobile terminal 20 obtains the location information by itself. Accordingly, there is a problem in that the onetime get-off ticket may be issued frequently unnecessarily and the moving section of each stop unit may not be clearly detected when compared with the method for using the stop ID as the location information. In order to compensate for this disadvantage, it is preferable to add a certain condition to the process of issuing the onetime get-off ticket. As an example of such a condition, a method for a onetime get-off ticket to be issued in a fixed distance unit or a fixed time unit may be used. For example, if the moving distance changes by more than 200 meters, the location of the bus B is detected or the location of the bus B is detected every minute, and as a result, the location of the next stop nearest to the current location of the bus B may be determined to be the get-off location.

On the other hand, with respect to the settlement in step S60 of FIG. 2, when the mobile terminal 20 is contracted with a separate fare system, the collection server 10 may settle based on the contract. As an example, the mobile terminal 20 may be freely contracted to use the subway or bus within a range of a fixed period, number of times, and section, and specifically, under the condition that the mobile terminal 20 freely uses a section between stations A and B up to 60 times a month, the mobile terminal 20 can make a contract by charging the corresponding fare in advance.

If such a contract exists, the collection server 10 only checks for boarding and getting off and does not collect additionally when the onetime boarding tickets and the onetime get-off tickets are issued within the range of the period, the number of times, and the section. However, if one of the period, the number of times, or the section exceeds the contracted range, it is regarded as a separate boarding regardless of the contract, and thus a separate collection corresponding thereto is made. By applying this method, the collection server 10 may separately perform a collection according to the corresponding fare system and a separate collection for a user who subscribes to a separate fare system.

Although the disclosure has been described with reference to one embodiment illustrated in the accompanying drawings, it is only an example. It will be understood by those skilled in the art that various modifications and other equivalent exemplary embodiments are possible from the present invention. Therefore, the actual technical protection scope of the present invention is to be defined by the claims.

What is claimed is:

1. A method for collecting a transportation fare performed by a collection server that communicates with a user mobile terminal and a validator provided for transportation means used by a user, the method for collecting a transportation fare comprising:
a) checking, by the collection server, whether the mobile terminal is located adjacent to the transportation means within a predetermined distance;
b) issuing, by the collection server, a onetime boarding ticket, which grants an authority to get on the transportation means at a current location of the mobile terminal, to the mobile terminal by checking that the mobile terminal is located adjacent to the transportation means in step a); and
c) transmitting a result of validating, by the validator, the onetime boarding ticket through short-range communication with the mobile terminal to the collection server and receiving, by the collection server, the validated result.

2. The method of claim 1, wherein the step a) includes:
a-1) receiving, by the mobile terminal, a signal from a signal generator fixed at a location adjacent to the transportation means; and
a-2) transmitting, by the mobile terminal, a signal generator ID, which is identification information of the signal generator received from the signal generator, to the collection server.

3. The method of claim 2, wherein in the step a-2), the mobile terminal transmits location information of the transportation means to the collection server.

4. The method of claim 3, wherein the location information is the signal generator ID.

5. The method of claim 2, further comprising:
after the step c),
d) checking, by the collection server, the location of the transportation means during movement of the transportation means;
e) issuing, by the collection server, a onetime get-off ticket, which grants an authority to get off the transportation means at the current location of the transportation means, to the mobile terminal; and
f) transmitting a result of validating, by the validator, the onetime get-off ticket through the short-range communication with the mobile terminal to the collection server and receiving, by the collection server, the validated result.

6. The method of claim 5, wherein the onetime get-off ticket is issued corresponding to the onetime boarding ticket.

7. The method of claim 6, wherein a unique number assigned to the onetime boarding ticket is added to the onetime get-off ticket.

8. The method of claim 5, wherein the step d) includes:
d-1) receiving, by the mobile terminal, a signal from another signal generator fixed at a location adjacent to the transportation means during the movement of the transportation means; and
d-2) transmitting, by the mobile terminal, another signal generator ID, which is identification information of the another signal generator received from the another signal generator, to the collection server.

9. The method of claim 8, wherein in the step d-2), the mobile terminal transmits the location information of the transportation means to the collection server.

10. The method of claim 9, wherein the location information is the another signal generator ID.

11. The method of claim 1, further comprising:
g) settling, by the collection server, a transportation fare for the mobile terminal according to the validated result in the step c).

12. The method of claim 5, further comprising:
g) settling, by the collection server, a transportation fare for the mobile terminal according to the validated result in the step f).

13. The method of claim 1, wherein the step a) includes:
a-1) receiving, by the mobile terminal, a signal from a signal generator provided in the transportation means; and
a-2) transmitting, by the mobile terminal, a signal generator ID, which is identification information of the signal generator received from the signal generator, to the collection server together with the location information of the transportation means.

14. The method of claim 13, wherein the location information includes at least one of a stop ID adjacent to the transportation means, a location of the mobile terminal, and a location calculated by a GPS device of the transportation means.

15. The method of claim 14, further comprising:
after the step c),
d) checking, by the collection server, the location of the transportation means during movement of the transportation means;
e) issuing, by the collection server, a onetime get-off ticket, which grants an authority to get off the transportation means at the current location of the transportation means, to the mobile terminal; and
f) transmitting a result of validating, by the validator, the onetime get-off ticket through the short-range communication with the mobile terminal to the collection server and receiving, by the collection server, the validated result.

16. The method of claim 15, wherein the onetime get-off ticket is issued corresponding to the onetime boarding ticket.

17. The method of claim 16, wherein a unique number assigned to the onetime boarding ticket is added to the onetime get-off ticket.

18. The method of claim 15, wherein the step d) includes:
d-1) receiving, by the mobile terminal, a signal from the signal generator provided in the transportation means during the movement of the transportation means; and
d-2) transmitting, by the mobile terminal, the signal generator ID received from the signal generator, to the collection server together with the location information of the transportation means.

19. The method of claim 18, wherein the location information of the transportation means includes the location of the mobile terminal calculated by a GPS device of the mobile terminal.

20. The method of claim 18, wherein the signal from the signal generator includes the location information of the transportation means.

21. The method of claim 20, wherein the location information of the transportation means includes at least one of a stop ID adjacent to the transportation means and a location calculated by the GPS device of the transportation means.

22. The method of claim 15, further comprising:
g) settling, by the collection server, a transportation fare for the mobile terminal according to the validated result in the step f).

23. The method of claim 1, wherein in the step c), the validator transmits the validated result to the collection server when it is checked whether the onetime boarding ticket is a ticket granting an authority to get on the transportation means at the current location.

24. The method of claim 1, wherein the onetime boarding ticket is limited in use time.

25. The method of claim 1, wherein the onetime boarding ticket is any one of a QR code ticket, an NFC ticket, and a Bluetooth ticket.

26. The method of claim 1, wherein the onetime boarding ticket is issued by reflecting a past boarding history of the user of the mobile terminal.

27. A method for collecting a transportation fare performed by a collection server that communicates with a user mobile terminal and a validator provided for transportation means used by a user, the method for collecting a transportation fare comprising:
a) checking, by the collection server, whether the mobile terminal is located adjacent to the transportation means within a predetermined distance, the step a) including a-1) receiving, by the mobile terminal, a signal from a signal generator fixed at a location adjacent to the transportation means and a-2) transmitting, by the mobile terminal, a signal generator ID, which is identification information of the signal generator received from the signal generator, to the collection server, and optionally transmitting location information of the transportation means together;
b) issuing, by the collection server, a onetime boarding ticket, which grants an authority to get on the transportation means at a current location of the mobile terminal, to the mobile terminal by checking that the mobile terminal is located adjacent to the transportation means in step a);
c) transmitting a result of validating, by the validator, the onetime boarding ticket through short-range communication with the mobile terminal to the collection server and receiving, by the collection server, the validated result;
d) checking, by the collection server, the location of the transportation means during movement of the transportation means, the step d) including d-1) receiving, by the mobile terminal, a signal from another signal generator fixed at a location adjacent to the transportation means during the movement of the transportation means, and d-2) transmitting, by the mobile terminal, another signal generator ID, which is identification information of the another signal generator received from the another signal generator, to the collection server, and optionally transmitting location information of the transportation means together;
e) issuing, by the collection server, a onetime get-off ticket configured to grant an authority to get off the transportation means at the current location of the transportation means to the mobile terminal and to correspond to the onetime boarding ticket;
f) transmitting a result of validating, by the validator, the onetime get-off ticket through the short-range communication with the mobile terminal to the collection server and receiving, by the collection server, the validated result; and
g) settling, by the collection server, a transportation fare for the mobile terminal according to the validated result in the step f).

28. A method for collecting a transportation fare performed by a collection server that communicates with a user mobile terminal and a validator provided for transportation means used by a user, the method for collecting a transportation fare comprising:
a) checking, by the collection server, whether the mobile terminal is located adjacent to the transportation means within a predetermined distance, the step a) including a-1) receiving, by the mobile terminal, a signal from a signal generator provided in the transportation means, and a-2) transmitting, by the mobile terminal, a signal generator ID, which is identification information of the signal generator received from the signal generator, to the collection server together with the location information of the transportation means, and the location information including at least one of a stop ID adjacent to the transportation means, a location of the mobile terminal, and a location calculated by a GPS device of the transportation means;
b) issuing, by the collection server, a onetime boarding ticket, which grants an authority to get on the transportation means at a current location of the mobile terminal, to the mobile terminal by checking that the mobile terminal is located adjacent to the transportation means in step a); and
c) transmitting a result of validating, by the validator, the onetime boarding ticket through short-range communication with the mobile terminal to the collection server and receiving, by the collection server, the validated result;
d) checking, by the collection server, the location of the transportation means during movement of the transportation means, the step d) including d-1) receiving, by the mobile terminal, a signal from the signal generator provided in the transportation means during the movement of the transportation means, d-2) transmitting, by the mobile terminal, the signal generator ID received from the signal generator, to the collection server together with the location information of the transportation means, and the location information including at least one of the location of the mobile terminal calculated by a GPS device of the mobile terminal, a stop ID adjacent to the transportation means, and a location calculated by a GPS device of the transportation means;
e) issuing, by the collection server, a onetime get-off ticket configured to grant an authority to get off the transportation means at the current location of the transportation means to the mobile terminal and to correspond to the onetime boarding ticket;
f) transmitting a result of validating, by the validator, the onetime get-off ticket through the short-range communication with the mobile terminal to the collection server and receiving, by the collection server, the validated result; and
g) settling, by the collection server, a transportation fare for the mobile terminal according to the validated result in the step f).
